(19) United States
(12) Patent Application Publication
(10) Pub. No.: US 2005/0034917 A1
(43) Pub. Date: Feb. 17, 2005

(54) Apparatus and method for acoustic position logging ahead-of-the-bit

(75) Inventors: Holger Mathiszik, Wathlingen (DE); Joachim Oppelt, Hannover (DE)

Correspondence Address: PAUL S MADAN;MADAN, MOSSMAN & SRIRAM, PC, 2603 AUGUSTA, SUITE 700, HOUSTON, TX, 77057-1130, US

(73) Assignee: Baker Hughes Incorporated, Houston, TX (US)

(21) Appl. No.: 10/641,356

(22) Filed: Aug. 14, 2003

(51) Int. Cl. G01V 1/00

(52) U.S. Cl. 181/108

(57) ABSTRACT

The present invention provides a method and apparatus for acoustic position logging ahead of a drill bit. The method and apparatus comprise a bottomhole assembly (BHA) conveyed on a drilling tubular in a borehole within an earth formation. The BHA has a source array for emitting preselected acoustic signals into the earth formation, and at least one receiver on the BHA for receiving a second acoustic signal produced by an interaction of the preselected acoustic signal with said formation. The source array for acoustic energy may be configured as an axially distributed array of axially or azimuthally directed sources, or an azimuthally distributed array of axially or azimuthally directed sources. The sources may be activated according to preselected time delays. The emitted acoustic signal is differing in spectrum and/or wave mode from the acoustic energy of a rotating drill string.

### FIELD OF THE INVENTION

The present invention is related to the field of geophysical exploration and more specifically to a method of using a seismic source to generate and acquire directional signals in a wellbore during drilling operations.

### BACKGROUND OF THE INVENTION

In the oil and gas industry, geophysical prospecting techniques are commonly used to aid in the search for and evaluation of subterranean hydrocarbon deposits. Generally, a seismic energy source is used to generate a seismic signal which propagates into the earth and is at least partially reflected by subsurface seismic reflectors (i.e., interfaces between underground formations having different acoustic impedances). The reflections are recorded by seismic detectors located at or near the surface of the earth, in a body of water, or at known depths in boreholes, and the resulting seismic data may be processed to yield information relating to the location of the subsurface reflectors and the physical properties of the subsurface formations.

Those skilled in the art have long recognized the importance of obtaining various borehole measurements during the course of a drilling operation. Typically, these measurements include such data as the weight imposed on the drill bit, the torque applied to the drill string, the inclination and azimuthal direction of the borehole interval that is then being drilled, borehole pressures and temperatures; drilling mud conditions as well as formation parameters including, but not limited to, resistivity and natural gamma emission of the earth formations being penetrated. Heretofore most of these measurements were obtained either by temporarily positioning special measuring devices in the drill string or by periodically removing the drill string and employing suitable wireline logging tools.

In recent years, however, the drilling technology has advanced sufficiently that these measurements can now be readily obtained by so-called measurement-while-drilling or “MWD” tools that are tandemly coupled in the drill string and operated during the drilling operation. Several MWD tools presently in commercial operation typically include a thick-walled tubular body carrying various sensors and their associated measurement-encoding circuitry which is positioned in the drill string just above the drill bit for measuring the conditions near the bottom of the borehole. These commercial tools generally employ a selectively-operable acoustic signaler which is cooperatively arranged in the tool body for successively transmitting encoded measurement signals through the drilling mud within the drill string to the surface where the signals are detected and recorded by suitable surface instrumentation.

The typical commercial MWD tool is arranged as a multi-sectional tool having various special-purpose modules that are respectively housed in separable thick-walled bodies and suitably arranged to be coupled together in various combinations for assembling an MWD tool capable of obtaining one or more selected measurements. The multiple sections require both mechanical and electrical connections, such as the prior art arrangement shown in FIG. 1. The illustrated components, known in the prior art, include sources and sensors for determining downhole formation characteristics. The prior art methods and apparatus include downhole tools comprising acoustic signal sources and sensors to determine, for example, subsurface formation velocity as the tool traverses the formation. This type of measurement does not provide for determining an image of subsurface formation reflectors before the drill bit has reached the reflectors.

In U.S. Pat. No. 6,131,694, Robbins discloses a vertical seismic profiling system including receivers on a drillstring and surface sources. The invention provides for one way check shots without tripping the drillstring. Downhole acoustic tools measures formation interval transit times and improves detection of targets ahead of the drill bit. The local interval transit time may be applied to the time of travel from reflections in front of the bit to establish distance to the bit. This invention does not provide for sources on the drill string.

In U.S. Patent Application Pub. No. US 2002/0159332 A1, Thomann et al disclose a method of estimating formation properties by analyzing acoustic waves that are emitted by a bottom hole assembly. A source signal is emitted from the bottom hole assembly and at lest one signal is received by one or more receivers in the bottom hole assembly. Analysis of the frequency dependent characteristics of the received signal allows the estimation of the formation properties of interest. This invention does not appear to provide for dipole or quadrupole sources, or for sources active when the drill bit is not in contact with the bottom-hole (i.e., off-bottom).

In U.S. Pat. No. 6,088,294, Legget et al, disclose an invention that provides a closed-loop system for drilling boreholes. The system includes a drill string having a drill bit and a downhole subassembly having a plurality of sensors and measurement-while-drilling devices, a downhole computing system and a two-way telemetry system for computing downhole bed boundary information relative to the downhole subassembly. The downhole subassembly includes an acoustic MWD system which contains a first set of acoustic sensors for determining the formation acoustic velocities during drilling of the wellbore and a second set of acoustic sensors that utilizes the acoustic velocities measured by the system for determining bed boundaries around the downhole subassembly. A computing system is provided within the downhole subassembly which processes downhole sensor information and computes the various parameters of interest including the bed boundaries, during drilling of the wellbore. In one embodiment, the first and second sets (arrangements) of acoustic sensors contain a transmitter and a receiver array, wherein the transmitter and some of the receivers in the receiver array are common to both sets of acoustic sensors. Each receiver in the receiver array further may contain one or more individual acoustic sensors. In one configuration, the distance between the transmitter and the farthest receiver in one of the acoustic sensor sets is substantially greater than the distance between the transmitter and center of the receivers in the second set. The downhole computing system contains programmed instructions, models, algorithms and other information, including information from prior drilled boreholes, geological information about the subsurface formations and the borehole drill path. This invention is directed to determining formation boundaries adjacent to the logging tool and not toward looking ahead of the tool in the direction of drilling.

In one embodiment of the Leggett et al invention, the acoustic system includes one acoustic sensor arrangement for determining the acoustic velocity of the formation surrounding the downhole tool, a second acoustic sensor arrangement for determining the first bed boundary information (such as the acoustic travel time an/or the distance), and a third acoustic arrangement for determining the second bed boundary information, independent of the first bed boundary information. Additionally, the acoustic sensor arrangement defined by the drill bit as the transmitter and an appropriate number of receivers may be utilized in determining the acoustic velocities and/or the bed boundary information. The multiple acoustic array arrangements provide for determining bed boundaries adjacent to the tool, as the tool traverses adjacent to the earth formation, but this arrangement is impractical for imaging ahead of the BHA in the direction of drilling.

U.S. Pat. No. 6,084,826 also to Leggett discloses an invention that provides apparatus and methods for obtaining acoustic measurements or “logs” of earth formations penetrated by a borehole. More particularly, the invention is directed toward obtaining the acoustic measurements while the borehole is being drilled. The downhole apparatus comprises a plurality of segmented transmitters and receivers which allows the transmitted acoustic energy to be directionally focused at an angle ranging from essentially 0 degrees to essentially 180 degrees with respect to the axis of the borehole. Downhole computational means and methods are used to process the full acoustic wave forms recorded by a plurality of receivers. A two way communication system is also used in the preferred embodiment of the invention.

The physical arrangement and firing sequences of the segmented transmitters in the Leggett disclosure are such that acoustic energy can be directed or focused into the formation in a predetermined azimuth and axial direction. This feature of the invention allows acoustic parameters to be measured in selected regions in the vicinity of the downhole assembly. Regions to be investigated can be selected in real time by sending commands from the surface or, alternately, can be preselected. As an example, the segmentation of transmitters allows measurements to be made ahead of the drill bit thereby providing the driller with critical information concerning formations and structures that have not yet been penetrated by the drill bit. The circumferential spacing of transmitters permits the focusing of transmitted acoustic energy azimuthally to determine the distance to adjacent bed boundaries in horizontal or highly deviated wells thereby assisting the driller in maintaining the drill bit within the formation of interest. It would be advantageous to be able to determine beds adjacent or ahead of the drill bit without the necessity to “direct or focus” the energy into the formation by using the multiple transmitters as in the Leggett disclosure.

U.S. Pat. No. 6,166,994 to Jeffryes discloses a method of exploring a subterranean formation ahead of a drill bit penetrating the formation. A bottom hole assembly is lowered into a borehole filled with a fluid. The assembly includes a drill bit, a source of acoustic energy and a plurality of receivers sensitive to acoustic energy. While operating the drill bit, acoustic energy is emitted from the source into the fluid and the formation, thereby generating a primary compressional wave travelling within the fluid and secondary compressional waves travelling within the fluid, which are converted into compressional waves at the bottom end of the borehole from acoustic energy reflected from within the formation. The primary compressional waves are detected. Information derived from detected primary compressional waves is used to detect the secondary compressional waves. The detected secondary compressional waves are then evaluated to obtain features of the formation ahead of the drill bit. According the disclosure, a disadvantage of the method is that events at a wide angle to the bit will be attenuated. It would be advantageous to have a method and apparatus capable of imaging features ahead of the drill bit, and at an angle (oblique) to the direction of drilling.

The methods and apparatus of the present invention overcome the foregoing disadvantages of the prior art by providing an integrated MWD system which provides for improved seismic imaging in the direction of drilling or in a directions oblique or parallel to the drill path.

There is a need for a method and apparatus to image geological features like faults, lithological changes, and pressure zones in the formation ahead of the drill bit. There is a need for an efficient method of generating directional sonic wave energy in a wellbore. There is a need for an acoustic borehole method and system that uses energy differing in its spectrum and wave mode from the background rotating drillstring. The present invention satisfies this need.

### SUMMARY

The present invention provides a method and apparatus for acoustic position logging ahead of a drill bit. The method and apparatus comprise a bottomhole assembly (BHA) conveyed on a drilling tubular in a borehole within an earth formation. The BHA has a source array for emitting preselected acoustic signals into the earth formation, and at least one receiver on the BHA for receiving a second acoustic signal produced by an interaction of the preselected acoustic signal with said formation. The source array for acoustic energy may be configured as an axially distributed array of axially or azimuthally directed sources, or an azimuthally distributed array of axially or azimuthally directed sources. The sources may be activated according to preselected time delays. The emitted acoustic signal is differing in spectrum and/or wave mode from the acoustic energy of a rotating drill string.

### BRIEF DESCRIPTION OF THE DRAWINGS

The present invention and its advantages will be better understood by referring to the following detailed description and the attached drawings in which:

FIG. 1 is a schematic of a prior art MWD downhole tool;

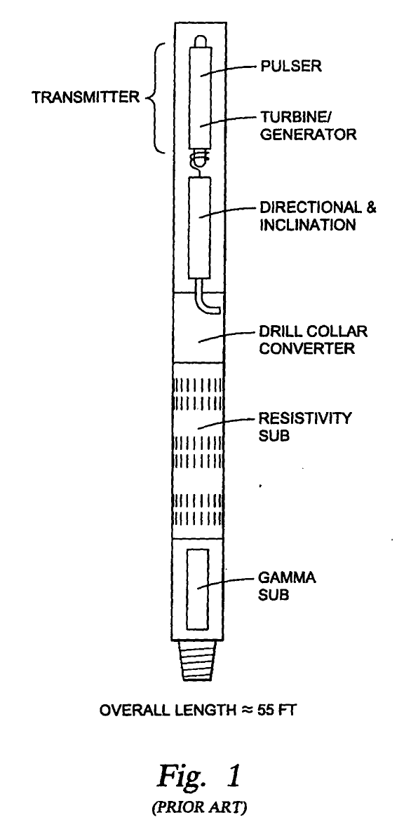

FIG. 2 is a schematic of a drilling system according to one embodiment of the present invention;

FIG. 3 illustrates a schematic diagram of an “on bottom” bottom hole assembly operation that includes an acoustic sensor system according to the present invention;

FIG. 4 illustrates a schematic diagram of an “off bottom” bottom hole assembly operation that includes an acoustic sensor system according to the present invention;

FIG. 5A illustrates an axial source array configuration for operating parallel to the wellbore axis;

FIG. 5B illustrates an azimuthal array with sources operating parallel to the wellbore axis;

FIG. 5C illustrates an axial array with sources operating perpendicular to the wellbore axis;

FIG. 5D illustrates an azimuthal array with sources operating perpendicular to the wellbore axis;

FIG. 6A illustrates an axial receiver array with source operating parallel to the well bore axis;

FIG. 6B illustrates an azimuthal receiver array with sources operating parallel to the wellbore axis;

FIG. 6C illustrates an axial receiver array with source operating perpendicular to the wellbore axis; and

FIG. 6D illustrates an azimuthal receiver array with source operating perpendicular to the wellbore axis.

While the invention will be described in connection with its preferred embodiments, it will be understood that the invention is not limited thereto. On the contrary, it is intended to cover all alternatives, modifications, and equivalents which may be included within the spirit and scope of the invention, as defined by the appended claims.

### DETAILED DESCRIPTION OF THE PREFERRED EMBODIMENTS

The present invention provides a method and system for using an acoustic logging tool conveyed in a borehole in an earth formation for determining a characteristic of the formation.

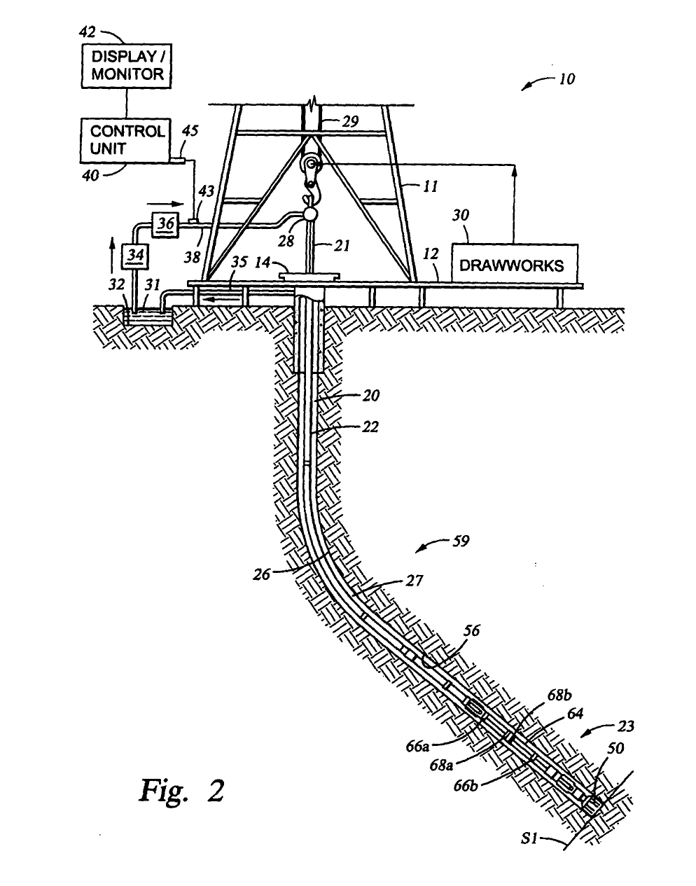

FIG. 2 shows a schematic diagram of a drilling system 10 having a downhole assembly containing a downhole sensor system and the surface devices according to one embodiment of present invention. As shown, the system 10 includes a conventional derrick 11 erected on a derrick floor 12 which supports a rotary table 14 that is rotated by a prime mover (not shown) at a desired rotational speed. A drill string 20 that includes a drill pipe section 22 extends downward from the rotary table 14 into a borehole 26. A drill bit 50 attached to the drill string downhole end disintegrates the geological formation 23 when it is rotated. The drill string 20 is coupled to a drawworks 30 via a kelly joint 21, swivel 28 and line 29 through a system of pulleys (not shown). During the drilling operations, the drawworks 30 is operated to control the weight on bit and the rate of penetration of the drill string 20 into the borehole 26. The operation of the drawworks is well known in the art and is thus not described in detail herein.

During drilling operations a suitable drilling fluid (commonly referred to in the art as “mud”) 31 from a mud pit 32 is circulated under pressure through the drill string 20 by a mud pump 34. The drilling fluid 31 passes from the mud pump 34 into the drill string 20 via a desurger 36, fluid line 38 and the kelly joint 21. The drilling fluid is discharged at the borehole bottom 51 through an opening in the drill bit 50. The drilling fluid circulates uphole through the annular space 27 between the drill string 20 and the borehole 26 and is discharged into the mud pit 32 via a return line 35. Preferably, a variety of sensors (not shown) are appropriately deployed on the surface according to known methods in the art to provide information about various drilling-related parameters, such as fluid flow rate, weight on bit, hook load, etc.

A surface control unit 40 receives signals from the downhole sensors and devices via a sensor 43 placed in the fluid line 38 or other appropriate places and processes such signals according to programmed instructions provided to the surface control unit. The surface control unit displays desired drilling parameters and other information on a display/monitor 42 which information is utilized by an operator to control the drilling operations. The surface control unit 40 contains a computer, memory for storing data, data recorder and other peripherals. The surface control unit 40 also includes models and processes data according to programmed instructions and responds to user commands entered through a suitable means, such as a keyboard. The control unit 40 is preferably adapted to activate alarms 44 when certain unsafe or undesirable operating conditions occur.

In a preferred embodiment of the present invention, the downhole drilling assembly 59 (also referred to as the bottomhole assembly or “BHA”) which contains the various sensors and MWD devices to provide information about the formation 23 and downhole drilling parameters, is coupled between the drill bit 50 and the drill pipe 22.

Referring to FIG. 2, the BHA 59 also contains downhole sensors and devices in addition to the above-described surface sensors to measure downhole parameters of interest. Such devices include, but are not limited to, a device for measuring the formation resistivity near the drill bit, a gamma ray device for measuring the formation gamma ray intensity, devices for determining the inclination and azimuth of the drill string, and pressure sensors for measuring drilling fluid pressure downhole. The above-noted devices transmit data to a downhole pulser or other transmission utility, which in turn transmits the data uphole to the surface control unit 40. The present invention utilizes telemetry techniques known in the art to communicate data from downhole sensors and devices during drilling operations to the surface control unit 40. For example with mud pulse telemetry, a transducer 43 placed in the mud supply line 38 detects the mud pulses responsive to the data transmitted by the downhole pulser 134. Transducer 43 generates electrical signals in response to the mud pressure variations and transmits such signals via a conductor 45 to the surface control unit 40. Alternatively, other telemetry techniques such electromagnetic and acoustic techniques or any other suitable technique may be utilized for the purposes of this invention.

In general, the present invention provides a method and system for seismic acquisition in the near well environment when drilling boreholes or “tripping” in and out of the well. The drilling system contains a drill string having a downhole subassembly that includes a drill bit at its bottom end and a plurality of sensors and measurement-while-drilling (MWD) devices, including an acoustic MWD system having a first set of acoustic sensors for determining the formation acoustic velocity while drilling the borehole and a second set of acoustic sensors for determining the bed boundaries by utilizing the acoustic velocity measurements made by the first set of acoustic sensors. A downhole computer and associated memory are provided for controlling various downhole operations, computing various downhole operating parameters, to determine formation characteristics and parameters, to map the formation around the downhole subassembly, to update stored models and data as a result of the computed parameters and to aid the driller in navigating the drill string along a desired wellbore profile. The computer may have one or more processors for determining acoustic signal characteristics and parameters.

The drilling system may also includes devices for determining the formation resistivity, gamma ray intensity of the formation, the drill string inclination and the drill string azimuth, nuclear porosity of the formation and the formation density. The drill string may contain other MWD devices known in the art for providing information about the subsurface geology, borehole conditions and mud motor operating parameters, such as the differential pressure across the mud motor, torque and the condition of the bearing assembly. Selected data is transmitted between the downhole subassembly and surface computing apparatus via a suitable telemetry system. Suitable telemetry systems are known in art and include two-way telemetry systems, multiple one-way systems like wet-connect cable, EM telemetry, etc. The surface computing apparatus transmits signals to the downhole subassembly for controlling certain desired operations and also for processing the received data according to programmed instruction to improve the drilling operations.

By implementation of an acoustic source or source array and a set of axially and radially distributed acoustic receivers on a BHA in a near-bit environment of a drillstring deployed in a fluid-filled borehole, an acoustic reflection measurement while drilling in direction of the wellbore axis ahead-of-the-bit is realized.

The acoustic source emits preselected acoustic energy differing in its spectrum and/or wave mode from the acoustic background noise generated by the rotating drillstring, the drill bit, and other downhole sources. The preselected acoustic energy may be impulsive or swept frequency signals as are known in the art. The energy propagates on different acoustic channels in axial or radial direction, resulting in a wavefield propagating through the wellbore formation interface into the formation. After reflection at a contrast in acoustic impedance axially ahead of the bit, the reflected wavefield re-enters the wellbore and is recorded by means of a variety of acoustic sensors.

The source is located in the drillstring near the bit. The source may directionally emit energy either axially into the steel drill pipe or radially into the inner and/or outer fluid column. There are several transmission channels for acoustic energy to travel to and into the formation “ahead of the bit.” One channel is from drill pipe to the earth formation via the bit-borehole bottom interface, e.g. in a drilling situation. If drilling operations are suspended such that the bit is not cutting formation, a transmission channel is from the bit or BHA to fluid column-formation and then the borehole bottom if the bit is operating in an off-bottom situation, or combinations of these situations.

The set of receivers comprises at least one three-component geophone in the drill pipe, and/or at least one three-component accelerometer in the drill pipe, and/or at least two hydrophones in the in-pipe fluid column, or at least two hydrophones in the wellbore annulus or copies of them. Alternatively the geophone and accelerometer sensors could be mounted on pads coupled directly over the BHA in radial and/or axial directions forming an array for enhanced detection. In a preferred embodiment a whole set of receivers of different types is spread over the BHA in radial and/or axial direction forming an array for enhanced detection. The reflected wavefield could be propagating and be recorded on acoustic paths different from the paths of the emitted wavefield.

By identifying the reflected energy with respect to wave mode and spectrum, the travel time of the acoustic wavefield from the source, via the reflector to the receiver, as well as by considering an adequate formation velocity obtained by a simultaneous delta-t measurement, the distance between bit and reflector is calculated. Additionally by utilizing a source and receiver array spread over the BHA as well as performing measurements over a certain depth interval along the borehole trajectory, imaging of the reflector and estimations of the formation's fluid and matrix properties between wellbore and reflector could be made. After downhole processing evaluation, and encoding, the information will be used in a downhole closed-loop system and/or will be transmitted to the surface by means of a data telemetry system to geosteer the drillstring into the target's direction.

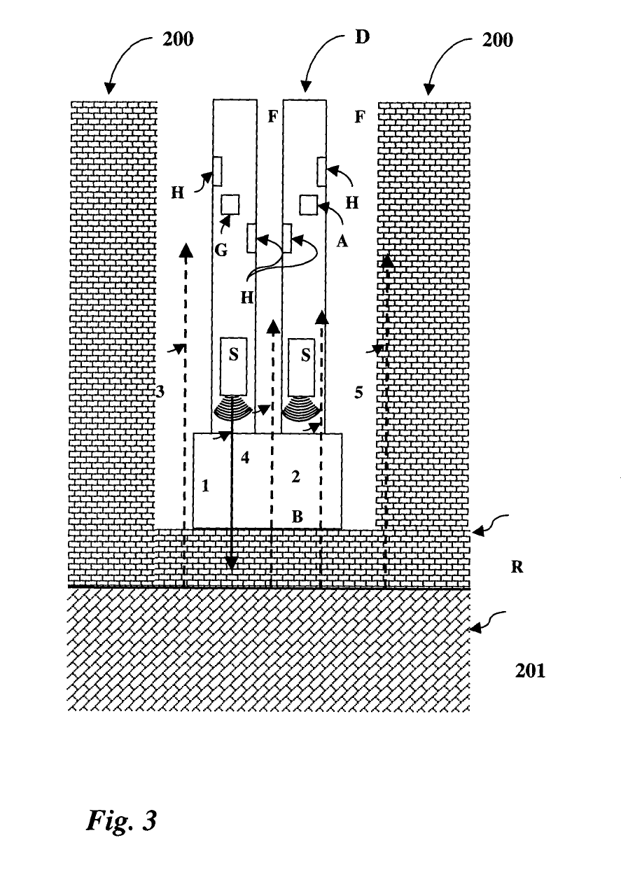

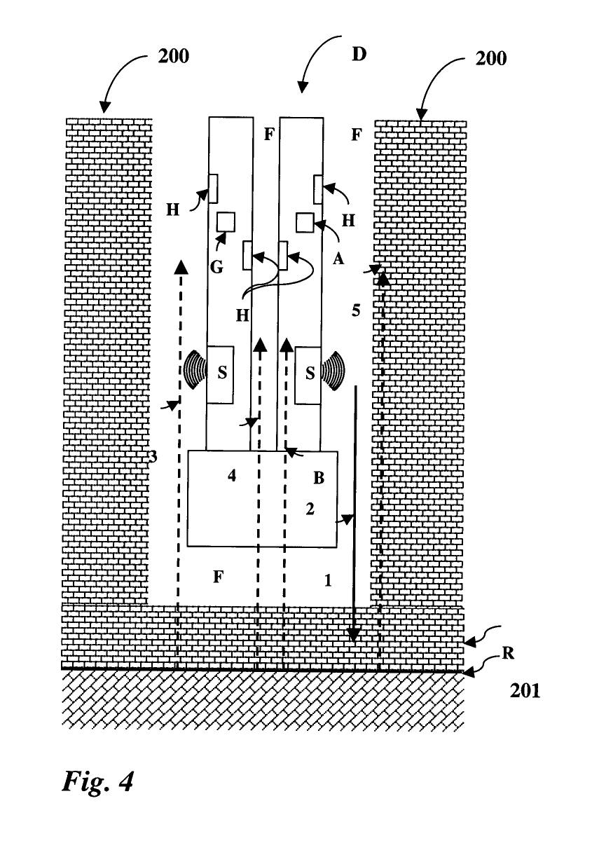

In FIG. 3 and FIG. 4 the general concept of the invented apparatus and method is illustrated. FIG. 3 illustrates the lower Bottom Hole Assembly (BHA) part of a drillstring D in a fluid filled F borehole. It should be appreciated that the method and system is not confined to the BHA, but may be placed anywhere on drill string. The BHA comprises the drill bit B, seismic sources S and receivers for example geophone G, accelerometer A and hydrophone H, in addition to other equipment. It will be appreciated by those versed in the art that sensors may be grouped into pressure devices and motion devices. Pressure devices are represented generically in this disclosure by the hydrophone H and may be hydrophones, fiber optic pressure sensors or other pressure sensor. Motion devices are represented herein interchangeably by geophones G or accelerometers A, which may be interchanged as far as their example position locations in the figures of this disclosure. Motion devices include geophones, accelerometers, MEMS (micromachined acceleration sensors), fiber optics (opto-acoustic sensors), etc.

The seismic sources S and receivers for example geophone G, accelerometer A and hydrophone H, in addition to other equipment may be on the drillstring D near the drill bit B on a drilling collar. A hydrophone is sensitive to variations in pressure, as opposed to a geophone or accelerometer which is sensitive to changes in particle motion (changes in position, velocity or acceleration). An accelerometer is a transducer whose output is proportional to acceleration.

The BHA travels through the earth formation 200. The drill bit B may in contact with the earth formation 200 and/or in the near vicinity of the bottom of the well bore (FIG. 3, is the ‘on bottom’ case) or in the well bore not in contact with the earth formation (FIG. 4, the ‘off bottom’ case). The method and apparatus of the present invention may be used for targeting a discontinuity R in the earth formation's acoustic properties (change in impedance) in the path of the drillstring/BHA ahead of the wellbore. The reflector or discontinuity R can separate earth formation 200 with one lithology from another adjacent earth formation 201 that can have a different lithology, thereby setting up the impedance contrast across the boundary that gives rise to reflective properties. The reflector or discontinuity R may be perpendicular to the well bore travel path, or at any angle to the well bore path. The abbreviations for FIGS. 3 and 4 are: R—reflector; F—borehole fluid; D—drillstring; B—bit; S—acoustic source; H—acoustic receiver=hydrophone; G—acoustic receiver=geophone; A—acoustic receiver=accelerometer. The number labels 1 through 5 represent acoustic energy channels and is further explained herein.

The present invention provides for a system and an apparatus located in the lower BHA near the drill bit B comprising an acoustic source S or a source array and a variety of sensors A, G, and/or H sensitive to acoustic energy, which in a preferred embodiment are optimised in their configuration for reflection detection measurements in the axial direction ahead-of-the-bit. The acoustic source or the source array emits energy differing in its spectrum and/or wave mode from the acoustic background noise generated by the rotating drillstring, the drill bit, and other downhole sources. Acoustic sources may be monopole, dipole or quadrupole sources. Sources may be impulsive, swept frequency or otherwise encoded. Source arrays may be coded such that individual firing patterns are enabled, including variable source energy levels or source amplitude emissions. Using sequential firing and variable source energy levels in this manner, sources effectively sum signals to a final signal. In a preferred embodiment the quadrupole mode of the acoustic wavefield is especially excited such that it may be distinguished from the background or ambient well environment acoustics.

Depending on the drilling situation (on-bottom, off-bottom, vertical well, deviated well), the acoustic energy travels along different waveguide channels 1 to 5, and is registered independently by the single sensors A, G, and/or H of the receiver system.

According to the drilling situation, the single sensor signals of various types are combined and evaluated to enable time-correcting, weighing and stacking, to produce signal traces containing the reflective response of the earth formation ahead-of-the-bit. Processing of various types of receiver signals together, whether pressure, velocity or displacement measurements, are well known in the art.

Parts or all of the data processing process is performed downhole to enable closed-loop information input into geosteering systems and to minimize the data telemetry requirements to the surface when necessary. Geosteering is directing a well bore so that it stays within a predetermined path or the same earth formation. Using additional information like formation velocity, depth and wellbore inclination obtained by downhole measurements or by a downhole information library defined prior to drilling, processing comprises the extraction of the reflected energy, whether reflectors are perpendicular, parallel or oblique to the well direction, the calculation of the bit-reflector distance, the imaging of the reflector and the estimation of the formation's fluid and matrix properties. In a preferred embodiment the source and receiver performance as well as the array spacing are optimised in a way to operate in a frequency range of 500 to 5000 Hz.

FIG. 3 illustrates a drilling stage with the bit B positioned “on-bottom,” which is to say in the vicinity of the bottom of the well bore. This situation may include lowered revolutions-per-minute (RPM) of the drill string, a source S that generates an acoustic signal directed in the axial direction to the travel of bit B. The source mechanism could be a broad-banded impulsive or swept frequency signal, including a bandwidth optimized to the aimed depth of investigation. Following path 1 the signal propagates through the steel body of the drillstring D and the bit B, into the earth formation. After reflection at a change in acoustic impedance (e.g. a change in lithology) R of the earth formation axially ahead of the bit B, the reflected signal re-enters the wellbore on the channels 2, 3, and 4, and is recorded by means of dedicated sensors H, G, A.

The source signal may be recorded by means of three component geophones G and/or accelerometers A placed in the drillstring D near the source location but at least two wavelengths away from the source S, i.e. in the source's far field. Alternatively, orthogonally arranged sensor components may be equivalently implemented. The portion of the signal re-entering the wellbore on channel 2 propagates through the formation-bit interface, the steel body of the bit B and drillstring D, and is registered as particle motion by means of three component geophones G and/or three component accelerometers A. On channel 3, signal energy propagates through the formation-annulus interface and is guided through the annulus as fluid pressure waves, recorded by means of hydrophone sensors H. A small amount of signal energy entering the wellbore will be focused in the downstream fluid column inside the drill pipe (channel 4) and will be detected by in-pipe hydrophone sensors H. On Channel 5 an amount of signal energy propagates in the formation along the borehole-formation interface emitting energy continuously into the fluid column overlaying with the energy propagating on channel 3. All recorded signals are stored in a downhole memory for surface dump. Additionally, depending on available data telemetry speed to the surface, at least three telemetry methods are possible (with further modifications possible according to the available transmission capacity). These methods include: 1) high speed data telemetry to the earth's surface (e.g. wired pipe or other drill pipe capable of transmitting high-bandwidth downhole data and surface control signals, or other methods also incorporating direct contact, inductive coupling or acoustic coupling data transmission methodology, etc.), 2) mudpulse or similar telemetry to the surface, and 3) downhole closed loop data evaluation.

If high speed data telemetry to the earth's surface is available, the recorded signals are downhole compressed for size reduction and transmitted to the surface in real or near-real time by means of a high speed data telemetry system. On the surface the different sensor measurements are filtered to remove or reduce drilling and circulation noise, and energy conversions between the different propagation channels (e.g. from steel body wave to tube wave) are removed. The different sensor signals are corrected for differences in travel-time due to different velocities along different waveguide channels. Considering a formation velocity obtained by a simultaneous delta-t measurement, additional evaluation steps are performed like deconvolution, fk-filtering, semblance processing, source-receiver cross-correlation, receiver signal correlation (smart or optimised signal stacking between A, G, and H signals), etc. The received acoustic information is then utilized for formation evaluation purposes ahead of the bit to obtain information relevant for geosteering. Considering additional information from surface, LWD and wireline measurements estimations of the formation's fluid and matrix properties could be made.

In conjunction with downhole processing, mudpulse data telemetry or similar may be used to send data to the surface. The recorded signals are ‘cleaned’ downhole for drilling and circulation noise, and energy conversions between the different propagation channels (e.g. from steel body wave to tube wave) are removed. Afterwards a ‘smart’ signal stacking procedure of adequate sensor outputs is incorporated downhole, performing a travel time correction and differentiating between signal/noise ratios of the different wave channels. The results may be compressed and transmitted to the surface by means of a medium speed data telemetry system. On the surface an evaluation cycle equivalent to the high speed telemetry system disclosed above takes place for reflection detection purposes.

A third possibility is downhole closed-loop data evaluation. Using, for example, downhole implemented artificial intelligence, full waveform downhole processing can be performed. The resulting information is fed by a closed-loop flow into the downhole control of a geosteering system for trajectory control. Additionally, one or more flag parameters may be created and transmitted to the surface for feedback purposes.

The off-bottom case (FIG. 4) can be distinguished from the on-bottom case due to its low noise environment. Usually applied during drilling connection setting operations or other low-noise drilling operation, the lack of drilling and circulation activity enhances the signal/noise ratio of the receiver recordings dramatically. On the other hand, due to the associated raise of the bit B 1.5 to 2 meters above the wellbore bottom, the propagation channels of acoustic energy differ from the ones in the on-bottom case.

In the off-bottom case illustrated in FIG. 4 drilling fluid F is between bit B and the wellbore bottom. This establishes a continuous fluid wave channel surrounding the drillstring D changing the drillstring-formation coupling. In this case the radiation characteristic of the acoustic source S can be a different one from the on-bottom case. Now the source S generates an acoustic signal propagating radially directly into the annulus fluid column F (or alternatively into the in-pipe fluid column) introducing a large amount of guided fluid waves propagating along the borehole wall-fluid (in-pipe wall-fluid) interface up and down the wellbore. At the wellbore bottom the guided fluid wave energy is split into a part reflected back into the borehole, and a part converted into body waves while propagating through the wellbore-formation interface. Beside a generally more attenuated signal, the reflection process at the reflector R as well as the recording process at the receivers A, G, and H follows the same wave channels as in the on-bottom case. The source signal is recorded by means of hydrophone sensors H placed in the drillstring near the source location but at least two wavelengths away from the source S, i.e. in the source's far field. After recording of source and reflected signal, the same data evaluation procedures in the three cases described above take place.

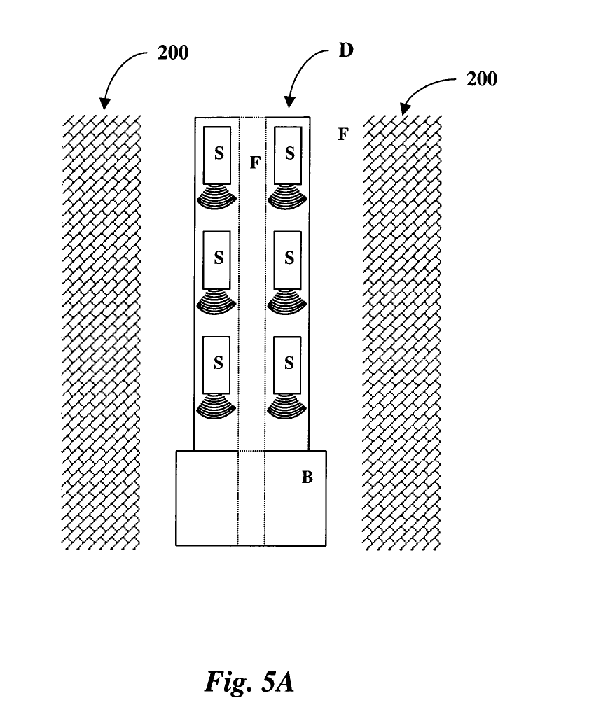

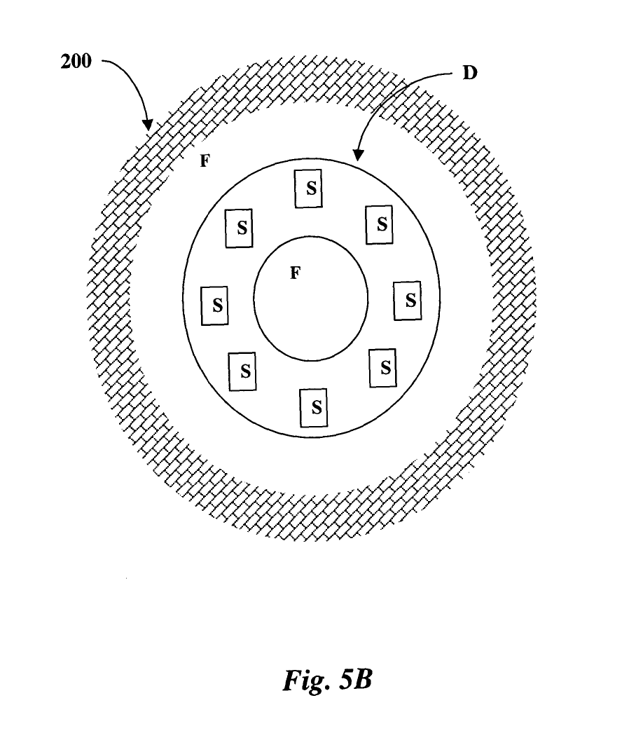

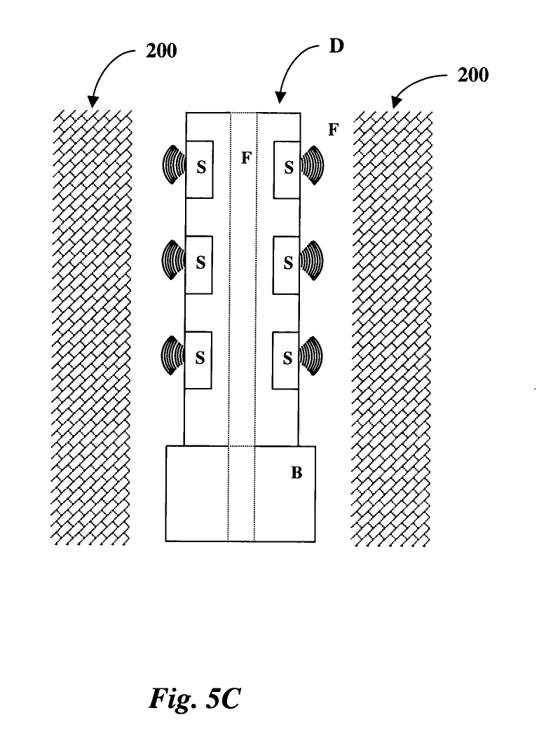

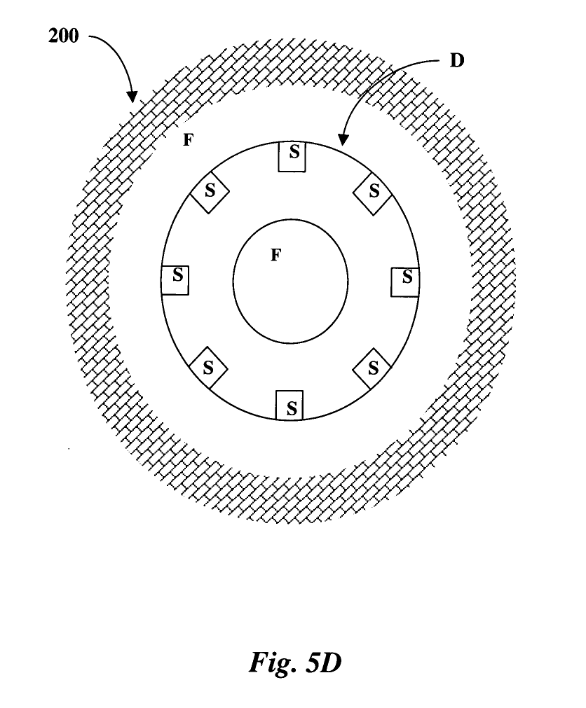

Alternatives to a single source are illustrated in FIGS. 5A through 5D. FIG. 5A illustrates an axial array with sources operating parallel to the wellbore axis (an axially distributed array of axially directed sources). FIG. 5C illustrates an axial array with sources operating perpendicular to the wellbore axis (an axially distributed array of azimuthally directed sources). FIG. 5B illustrates an azimuthal array with sources operating axially, parallel to the wellbore axis (an azimuthally distributed array of axially directed sources). FIG. 5D illustrates an azimuthal array with sources operating perpendicular to the wellbore axis (an azimuthally distributed array of azimuthally directed sources). By activating the elements of these arrays sequentially in a time-delayed manner a directional wavefield can be generated which may contain constructive interference and destructive interference. By this a spatially directed source signal with enhanced amplitude can be obtained generating dedicated wavemodes in the wellbore and surrounding formation. In a preferred embodiment the elements of the source array S are activated to generate a dipole or quadrupole wavefield enabling measurements of the formation's properties in both slow and fast formations. Dipole and quadrupole sources have definite advantages with respect to avoiding undesirable signals traveling through the drillstring.

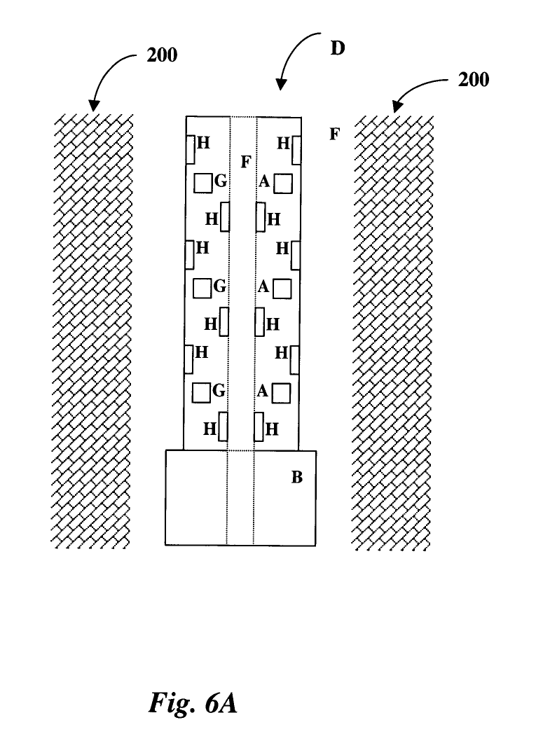

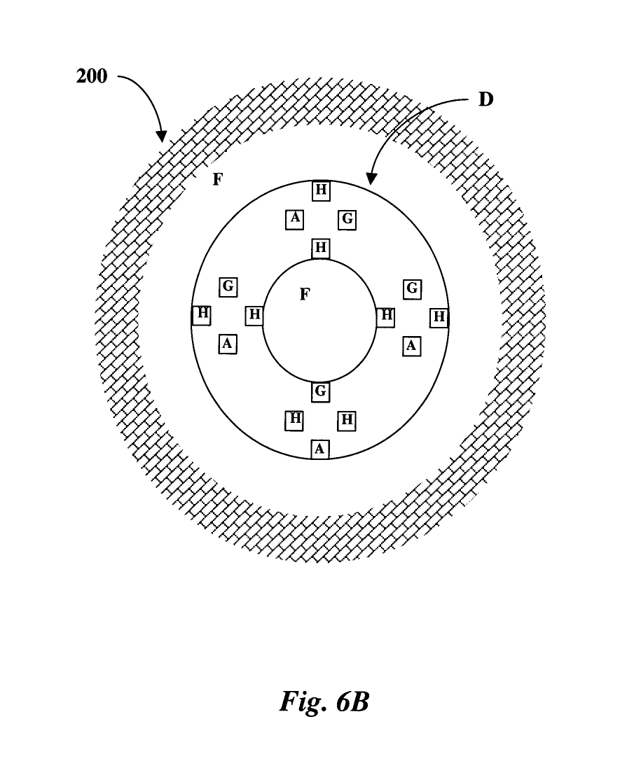

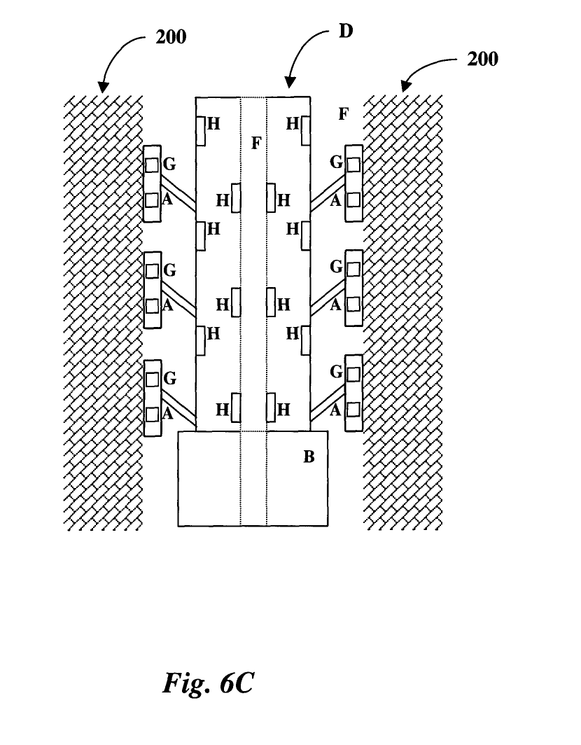

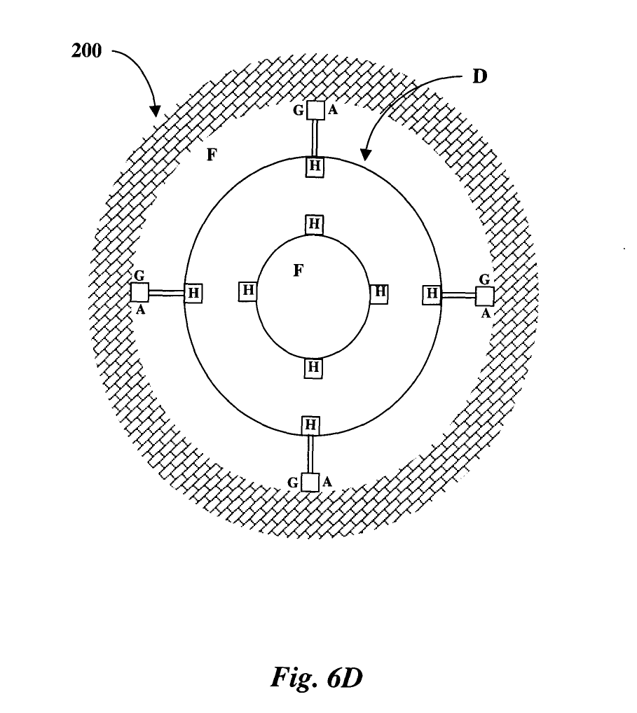

For enhanced signal registration in terms of signal-noise-ratio and directivity, receiver arrays can be distributed axially (FIGS. 6A and 6B) and/or azimuthally (FIGS. 6B and 6D). FIG. 6A illustrates an axial array with sources operating parallel to the wellbore axis. FIG. 6B illustrates an azimuthal array with sources operating parallel to the wellbore axis. FIG. 6C illustrates an axial array with sources operating perpendicular to the wellbore axis. FIG. 6D illustrates an azimuthal array with sources operating perpendicular to the wellbore axis. In a preferred embodiment the receiver elements acquiring particle motion G and acceleration A are mounted on pad devices, distributed axially (FIG. 6C) and/or azimuthally (FIG. 6D) along the drillstring, coupled to the formation while drilling. This enhancement of signal acquisition in terms of signal-noise-ratio is achieved due to minimizing the influence of fluid-guided energy.

The implementation of the present invention may be carried out in many different ways. Other implementations and embodiments will be apparent to those versed in the art without departing from the true scope of the invention. Further, it should be understood that the invention is not to be unduly limited to the foregoing which has been set forth for illustrative purposes. Various modifications and alternatives will be apparent to those skilled in the art without departing from the true scope of the invention as defined in the following claims.

1. An acoustic logging apparatus comprising:
(a) a bottomhole assembly (BHA) conveyed on a drilling tubular in a borehole within an earth formation, said BHA comprising a source array for emitting preselected acoustic signals into the earth formation; and
(b) at least one receiver on the BHA for receiving a second acoustic signal produced by an interaction of said preselected acoustic signals with said formation.

2. The apparatus of claim 1 wherein said at least one source comprises at least one of i) an axially distributed array of axially directed sources, ii) an azimuthally distributed array of axially directed sources, iii) an axially distributed array of azimuthally directed sources, and iv) an azimuthally distributed array of azimuthally directed sources.

3. The apparatus of claim 2 further comprising activating said source array according to at least one of: i) pre-selected sequential time delays, ii) pre-selected energy levels and iii) coded activation sequences.

4. The apparatus of claim 1 further comprising at least one source array for emitting said preselected acoustic signals which is differing in at least one of i) a spectrum and ii) a wave mode from acoustic energy of a rotating drillstring.

5. The apparatus of claim 1 further comprising said at least one source array that emits at least one of: i) a monopole acoustic signal, ii) a dipole acoustic signal, and iii) a quadrupole acoustic signal.

6. The apparatus of claim 1 wherein said at least one receiver is located a distance at least two wavelengths from an element of said source array.

7. The apparatus of claim 6 wherein said at least one receiver comprises a plurality of receivers for receiving said second signal and comprise at least one of: i) a pressure sensor, and ii) a motion sensor.

8. The apparatus of claim 7 wherein said plurality of receivers for receiving said second signal include a hydrophone, an accelerometer and a geophone.

9. The apparatus of claim 7 wherein said plurality of receivers for receiving said second signal include at least one of i) an accelerometer and ii) a geophone, said receivers adjustably located to contact the earth formation.

10. The apparatus of claim 1 wherein said at least one receiver receives said second signal that has traversed part of said earth formation.

11. A method of obtaining information about a parameter of interest of an earth formation, the method comprising:
(a) using a drillbit on a bottom hole assembly (BHA) conveyed on a drilling tubular for drilling a borehole in said earth formation;
(b) suspending drilling operations and using said drilling tubular to move said drillbit away from a bottom of the borehole;
(c) generating an acoustic signal into said earth formation using an acoustic source array on the BHA; and
(d) determining said parameter of interest from a received signal resulting from an interaction of the generated acoustic signal with the earth formation.

12. The method of claim 11 wherein generating said acoustic signal further comprises sequentially activating elements of said acoustic source array.

13. The method of claim 11 wherein generating said acoustic signal further comprises activating elements of said acoustic source array in the borehole axial direction according to at least one of: i) pre-selected sequential time delays, ii) pre-selected energy levels and iii) coded activation sequences.

14. The method of claim 11 wherein said received signal has traversed part of said earth formation that is adjacent to said borehole.

15. The method of claim 11 wherein determining a parameter of interest further comprises defining a reflector imaging direction that is at least one of: i) parallel to the axis of the borehole, ii) oblique to the axis of the borehole, and iii) perpendicular to the axis of the borehole.

16. The method of claim 11 wherein said generated acoustic signal is differing in at least one of: i) a spectrum of acoustic energy of a rotating drillstring, and ii) a wave mode from acoustic energy of a rotating drillstring.

17. The method of claim 11 wherein said generated acoustic signal is at least one of: i) a monopole acoustic signal, ii) a dipole acoustic signal, and iii) a quadrupole acoustic signal.

18. A system for determining a property of an earth formation using an acoustic logging tool on a bottomhole assembly (BHA) in a borehole in said earth formation, the system comprising:
(a) at least one source array in said acoustic logging tool for generating preselected acoustic signals into said formation, said preselected acoustic signal differing in spectrum and/or wave mode from acoustic energy of a rotating drillstring;
(b) a plurality of receivers on said logging tool for receiving signals indicative of said parameter of interest;
(c) acquiring signals at a plurality of depths of said BHA; and
(d) processing said acquired signals to obtain the parameter of interest.

19. The system of claim 18 wherein said signals are acquired when the BHA is not in contact with the bottom of the borehole.

20. The system of claim 18 wherein said at least one source array comprises at least one of i) an axially distributed array of axially directed sources, ii) an azimuthally distributed array of axially directed sources, iii) an axially distributed array of azimuthally directed sources, and iv) an azimuthally distributed array of azimuthally directed sources.

21. The system of claim 20 further comprising sequentially firing said at least one source array in the borehole axial direction according to at least one of: i) pre-selected sequential time delays, ii) pre-selected energy levels and iii) coded activation sequences.

22. The system of claim 18 wherein processing said acquired signals further comprises defining an imaging ahead of the drillbit along the axis of the borehole.

23. The system of claim 18 wherein processing said acquired signals further comprises combining receiver signals from at least one of i) a pressure sensor, and ii) a motion sensor.

24. The system of claim 18 wherein processing said acquired signals further comprises defining time shifts according to a pre-selected imaging direction.

25. The system of claim 18 wherein processing said acquired signals further comprises compressing and transmitting said signals to the surface in substantially real time.

26. The system of claim 18 wherein processing said acquired signals further comprises full waveform processing in the BHA.

27. The system of claim 25 wherein information from said full waveform processing in the BHA is used for downhole control of a geosteering system.

28. The system of claim 18 wherein said plurality of receivers for receiving said signals indicative of a parameter of interest include at least one of i) an accelerometer and ii) a geophone, said receivers adjustably located to contact the earth formation.
